(19) United States
(12) Patent Application Publication
(10) Pub. No.: US 2019/0337626 A1
(43) Pub. Date: Nov. 7, 2019

(54) SYSTEM FOR CONNECTING AND SUPPORTING FOAM DUCTING SUBJECT TO AXIAL MOVEMENT

(71) Applicant: SPIRIT AEROSYSTEMS, INC., WICHITA, KS (US)

(72) Inventors: Allen D. Gerdes, Benton, KS (US); John M. Brannon, Kechi, KS (US); Rita Rai, Wichita, KS (US)

(73) Assignee: SPIRIT AEROSYSTEMS, INC., WICHITA, KS (US)

(21) Appl. No.: 15/968,333

(22) Filed: May 1, 2018

(51) Int. Cl. B64D 13/06; B60H 1/00; F16L 27/12

(52) U.S. Cl. CPC B64D 13/06; B60H 1/00528; B64D 2013/0603; F16L 27/12; B60H 1/00564

(57) ABSTRACT

A system for connecting and supporting foam ducting in, e.g., an aircraft. A slip joint element connects segments of the ducting and a sliding support element supports the ducting while accommodating an axial movement of the ducting due to thermal expansion and contraction or other operational forces. The slip joint includes male and female components installed on ends of adjacent segments of ducting. The male component is slidingly received within the female component, such that when the segments move along the axis the male component slides but remains received within the female component. The sliding support includes a receiver component slidingly received within a channel of a mounting component. The receiver component engages a fixed support bracket structure and the mounting component is mounted on an exterior surface of the ducting, such that when the ducting moves along the axis the receiver component slides but remains received within the channel.

### FIELD

The present invention relates to systems for connecting and supporting foam ducting, and more particularly, embodiments concern a system including a slip joint element for connecting segments of foam ducting and a sliding support element for supporting the foam ducting while accommodating an axial movement of the foam ducting due to thermal expansion and contraction or other operational forces.

### BACKGROUND

Foam ducting, such as is used in the environmental control systems (ECS) of aircraft, is typically subject to high coefficients of thermal expansion. This results in large expansion and contraction of ducts throughout their operating envelope. Movement at the ends of ducts can lead to high forces at joints and possible disconnections. Conventional designs use fixed-brackets at each end of a duct to restrain, or anchor, the ends and prevent them from moving and pulling loose at their mating connections. While this solves the problems of high forces and disconnections, the duct geometry and routing between these anchors must be configured so that they incorporate expansion and contraction features, or bends, between the fixed-brackets, which limits the applications in which foam ducting can be used. Additionally, supports between the anchors must be sized such that they can restrain the forces resulting from the movement, which adds cost and weight.

Slip joints have been used in duct systems, but these only address movement at the connection point and do not account for movement of the duct relative to its supporting structure throughout its length. Bellows-style joints have also been used in duct systems, but these do not control the movement direction. Rigid members, or “spars,” have been attached to the duct to restrain movement, but such members increase the cost of fabricating ducts, add complexity to the duct assembly, and increase stresses inside the duct.

This background discussion is intended to provide information related to the present invention which is not necessarily prior art.

### SUMMARY

Embodiments address the above-described and other problems and limitations by providing a system including a slip joint element for connecting segments of foam ducting and a sliding support element for supporting the foam ducting while accommodating an axial movement of the foam ducting due to thermal expansion and contraction or other operational forces.

In an embodiment of the present invention, a system is provided for accommodating movement of a foam ducting system. The system may comprise a slip joint element and a sliding support element. The slip joint element may include a male component configured to be installed on a first end of a first segment of a foam ducting and a female component configured to be installed on a second end of a second segment of the foam ducting. The male component may be configured to be slidingly received within the female component such that when the first segment moves along a centerline axis of the foam ducting relative to the second segment the male component slides but remains received within the female component, and thereby maintains a connection between the first and second segments. The sliding support element may include a receiver component configured to engage a fixed support bracket structure and a mounting component configured to be mounted on an exterior surface of the foam ducting. The receiver component may be configured to be slidingly received within an elongated channel of the mounting component such that when the foam ducting moves along the centerline axis the receiver component slides but remains received within the channel, and thereby maintains a connection between the foam ducting and the fixed support bracket structure.

Various implementations of the foregoing embodiment may include any one or more of the following additional features. The system may be incorporated into an environmental control system of an aircraft. The male component may include a first receiver component configured to receive the first end of the first segment, and a first extension component projecting outwardly from the first receiver component, and the female component may include a second receiver component configured to receive the second end of the second segment, and a second extension component projecting outwardly from the second receiver component, and configured to slidingly receive the first extension component of the male component when the male and female components are connected. The first receiver component may include a first channel for receiving the first end of the first segment, and the second receiver component may include a second channel for receiving the second end of the second segment. A first projection length of the first extension component and a second projection length of the second extension component may be determined based on an expected maximum distance between the first and second ends of the first and second segments as the first and second segments move along the centerline axis. An elongation length of the channel feature may be determined based on an expected maximum travel of the receiver component within the channel as the foam ducting moves along the centerline axis.

The slip joint element may further include a stop feature configured to limit the maximum relative movement of the male and female components and thereby prevent the male and female components from disconnecting. The slip joint element may further include an air seal interposed between the male and female components and configured to reduce a loss of air from between the first and second segments. The system may further include a mechanical or non-mechanical mechanism configured to secure the mounting component of the sliding support element to the exterior surface of the foam ducting.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is an isometric view of an embodiment of a system for supporting foam ducting subject to axial movement;

FIG. 2 is a perspective view of an embodiment of a slip joint element of the system of FIG. 1;

FIG. 3 is cross-sectional isometric view of the slip joint element installed on example foam ducting;

FIG. 4 is an isometric view of the slip joint element installed on the example foam ducting;

FIG. 5 is a perspective view of an embodiment of a sliding support element of the system of FIG. 1;

FIG. 6 is a perspective view of the sliding support element installed on the example foam ducting;

FIG. 7 is an isometric view of the sliding support element installed on the example foam ducting and cooperatively engaged with an example fixed support bracket structure.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Broadly characterized, the present invention provides a system for connecting and supporting foam ducting. More particularly, embodiments provide a system including a slip joint element for connecting segments of foam ducting and a sliding support element for supporting the foam ducting while accommodating an axial movement of the foam ducting due to thermal expansion and contraction or other operational forces.

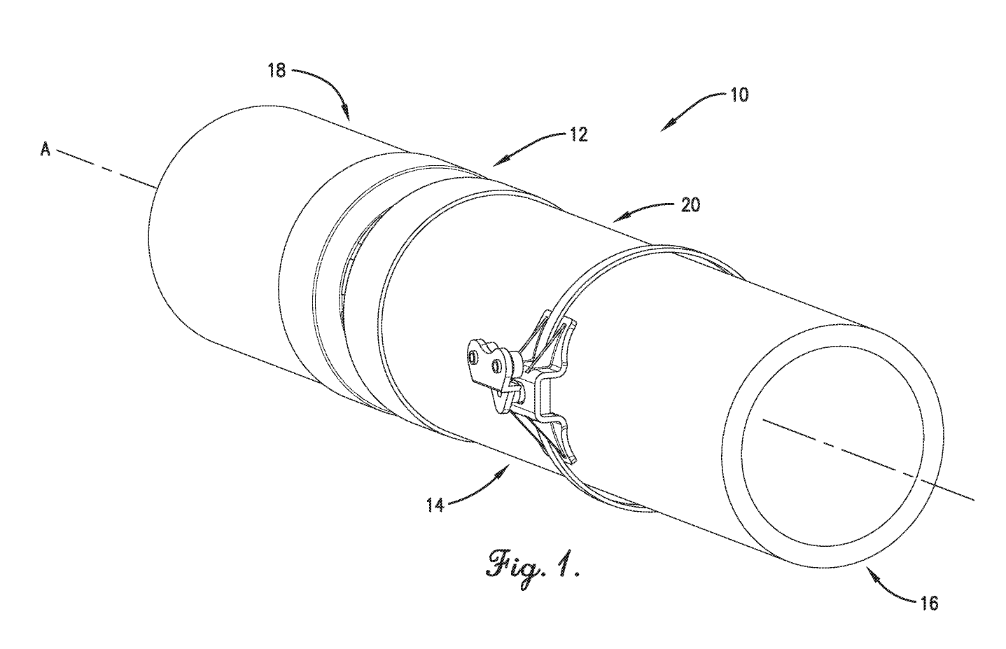

Referring to FIG. 1, an embodiment of the system 10 is shown including the slip joint element 12 and the sliding support element 14 installed on example foam ducting 16. It will be appreciated that a plurality of the slip joint elements and/or a plurality of the support elements may be used depending on the length, shape, and/or other design features of the foam ducting. The slip joints may be configured to replace existing ducting connectors, and the sliding support elements may be configured to interface with existing fixed support bracket structures.

The foam ducting may be substantially any suitable conventional or non-conventional foam ducting. In general, the foam ducting may take the form of an elongated structure having one or more walls constructed of foam and which define an internal passage. In one implementation, the foam ducting may include a plurality of segments configured to be arranged end-to-end to form an elongated structure of substantially any desired length. The foam ducting and/or the internal passage may have substantially any suitable cross-sectional shape, such as round, oval, square, or rectangular. In operation, one end of the elongated structure may be connected to an inlet and the other end of the elongated structure may be connected to an outlet, and air or another gas may flow through the internal passage from the inlet to the outlet.

In one implementation, the system and the foam ducting may be part of an ECS of an aircraft. Foam ducting is a recent technology for use in aircraft and is lower in cost and more durable than traditional composite ducting. However, the use of foam ducting has been limited because it expands and contracts in response to temperature changes. Embodiments of the system advantageously allow increased use of foam ducting in the ECS sub-systems of aircraft by eliminating fixed brackets at the ends of the ducting and reducing constraints on routing geometry imposed by prior art solutions, and provides a competitive advantage by bringing more low cost, durable foam ducting to the market.

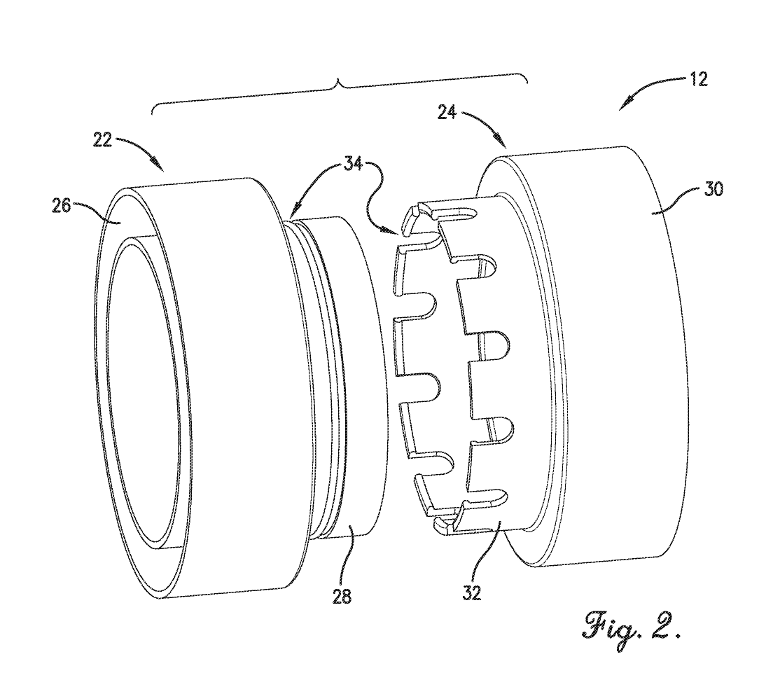

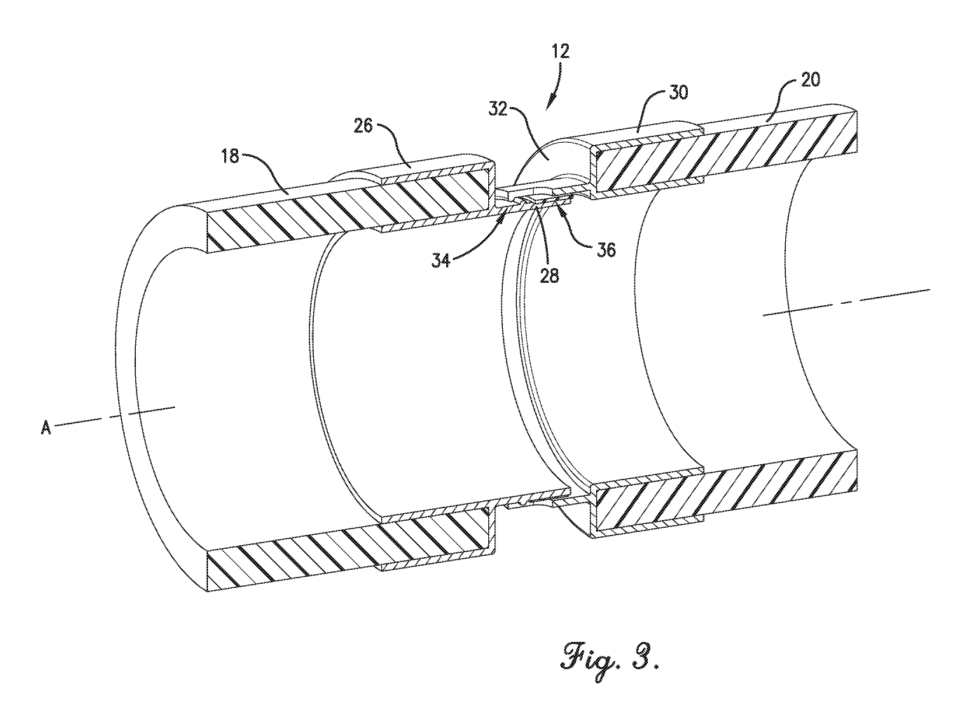

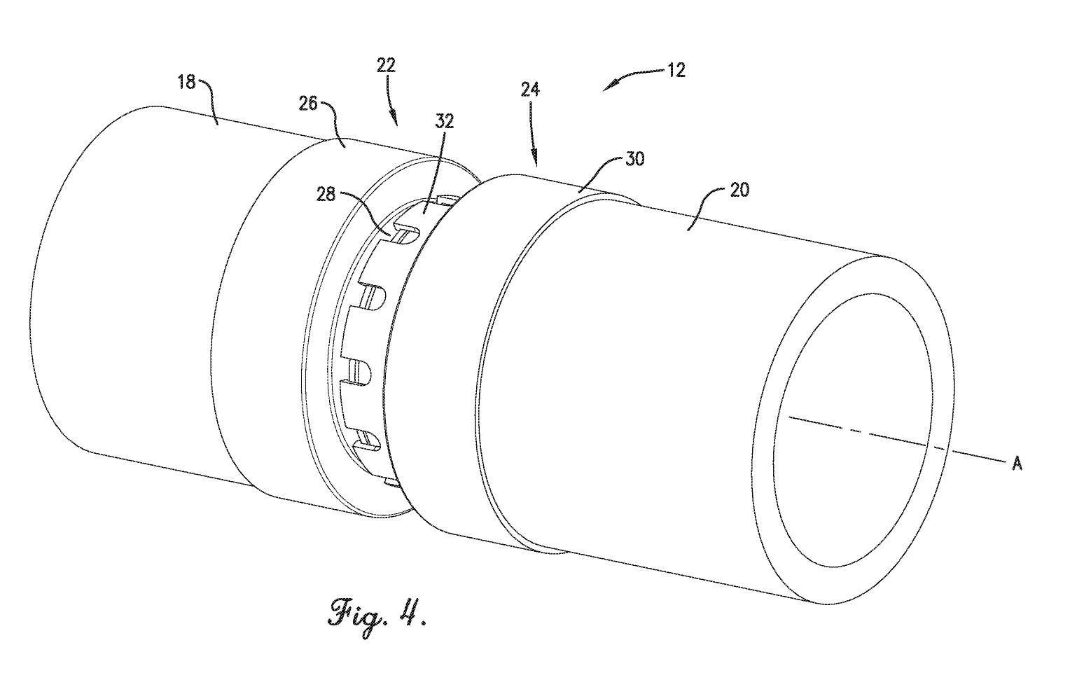

Referring to FIGS. 2-4, the slip joint element 12 may be interposed between and connect first and second segments 18,20 of the foam ducting 16 while allowing the foam ducting 16 to expand and contract axially along a centerline axis “A” of the foam ducting 16. An embodiment of the slip joint element 12 may include a male component 22 and a female component 24. The male component 22 may be installed on a first end of the first segment 18 of the foam ducting 16, and the female component 24 may be installed on a second end of the second segment 20 of the foam ducting 16. The male component 22 may be slidingly received within the female component 24 such that when the first segment 18 moves along the centerline axis “A” relative to the second segment 20 the male component 22 slides but remains received within the female component 24.

An embodiment of the male component 22 may include a first receiver component 26 and a first extension component 28. An embodiment of the female component 24 may include a second receiver component 30 and a second extension component 32. The first receiver component 26 may be configured to securely receive or otherwise engage an end portion of the first segment 18 of the foam ducting 16, and the second receiver component 30 may be configured to securely receive or otherwise engage an end portion of the second segment 20 of the foam ducting 16. In one implementation, the first and second receiver components may be substantially identical in form and function, with each receiver component including a channel configured to engage by receiving the end portion of the respective segment. The first extension component 28 may project outwardly from the first receiver component 26, and may be configured to be slidingly received under or within the second extension component 32 of the female component 24. The second extension component 32 may project outwardly from the second receiver component 30, and may be configured to slidingly pass over or outside of or otherwise receive the first extension component 28 of the male component 22.

During operation, as the first and second segments 18,20 of the foam ducting 16 expand and contract, the ends of the first and second segments 18,20 move together and apart, and the first and second extension components 28,32 slide relative to each other while remaining engaged and maintaining the overall integrity of the foam ducting 16. As such, the projection lengths of the first and second extension components 28,32 may be based on the expected minimum and maximum distances between the ends of the first and second segments 18,20 as they move together and apart.

The slip joint element 12 may include a stop feature 34 configured to limit the maximum relative movement of the first and second extension components 28,32 and thereby prevent the male and female components 22,24 from disconnecting. In one implementation, the stop feature 34 may take the form of corresponding lips or other projections at the ends of the extension components 28,32 which mechanically abut or otherwise engage each other to prevent movement in excess of the maximum relative movement. The slip joint element 12 may further include an air seal feature 36 interposed between the first and second extension components 28,32 and configured to reduce a loss of air from between the first segment and the second segment 18,20 maintain the overall integrity of the foam ducting 16. The slip joint element 12 may be constructed of plastic, resin, metal, or any suitable material or combinations of materials.

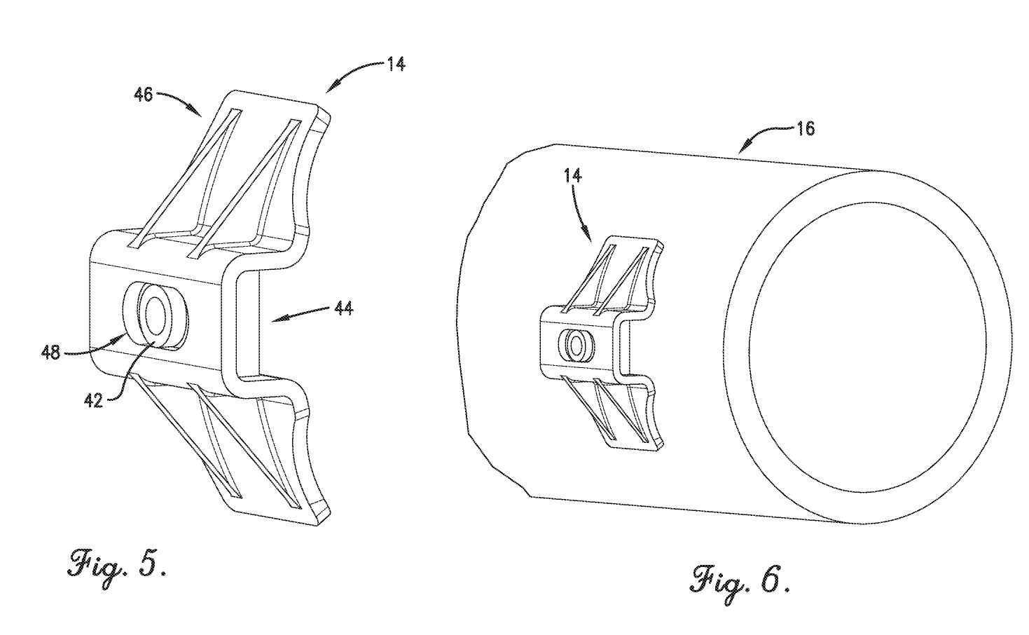

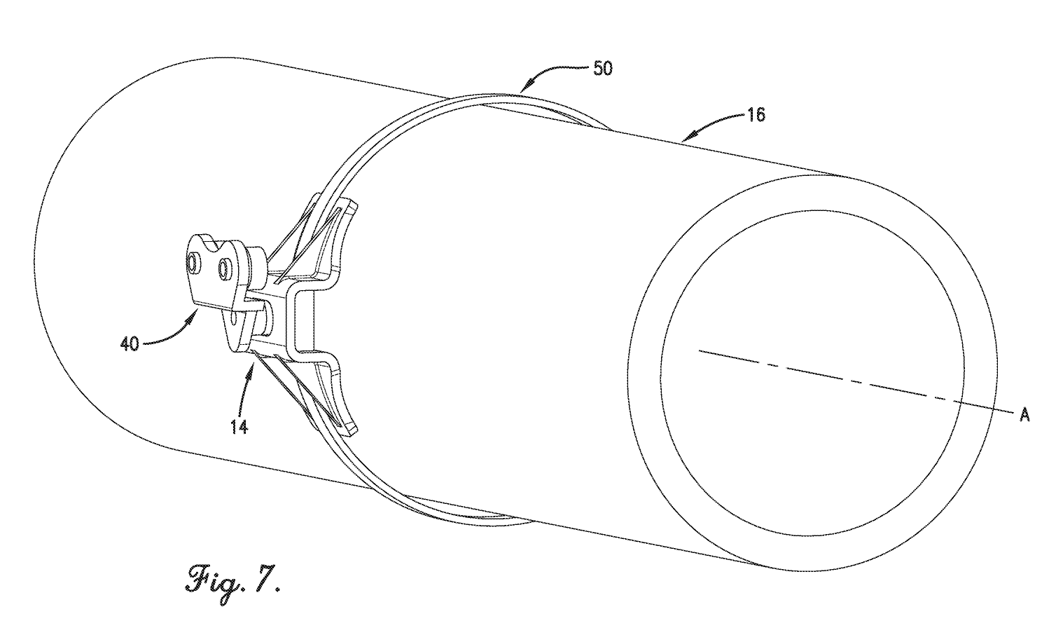

Referring to FIG. 5-7, the sliding support element 14 may be mounted to an exterior surface of the foam ducting 16 and allow the foam ducting 16 to cooperatively engage a fixed support bracket structure 40 which supports the foam ducting 16 while allowing the foam ducting 16 to expand and contract axially along the centerline axis “A” of the foam ducting 16. An embodiment of the sliding support element 14 may include a receiver component 42, a body component 44, and a mounting component 46. The receiver component 42 may be configured to securely engage the fixed support bracket structure 40. The receiver component 42 may be secured to the fixed support bracket structure 40 by a bolt, screw, or other suitable mechanism. In one implementation, the receiver component 42 may include an opening configured to receive or otherwise engage a corresponding feature on the fixed support bracket structure 40, while in another implementation, the fixed support bracket structure 40 may include an opening configured to receive or otherwise engage a corresponding feature on the receiver component 42.

The body component 44 may include a channel feature 48 which is elongated in a direction which is parallel to the centerline axis “A,” with the channel feature configured to slidingly receive the receiver component 42. An elongation length of the channel feature 48 may be determined based on an expected maximum travel of the receiver component 42 within the channel feature 48 as the foam ducting 16 moves along the centerline axis “A”.

The mounting component 46 may be attached to, integral with, or otherwise associated with the body component 44 and configured to be mounted on an exterior surface of the foam ducting 16 and thereby secure the sliding support element 14 to the foam ducting 16. The mounting component 46 may be mounted to the foam ducting 16 by a retaining structure 50 which may be a strap, clamp, or other suitable mechanical mechanism, or an adhesive or other suitable non-mechanical mechanism.

During operation, as the foam ducting 16 expands and contracts, the body and mounting components 44,46 move along the centerline axis “A” relative to the fixed support bracket structure 40 and the receiver component 42 slides within the channel feature 48 of the body component 44 to accommodate the relative movement and maintain the overall support of the foam ducting 16 from the fixed support bracket structure 40.

The sliding support element may be constructed of plastic, resin, metal, or any suitable material or combination of materials.

Thus, the system allows foam ducting, which is subject to expansion and contraction or similar movement, to be installed and supported without restraining the expansion and contraction forces or risk disconnection. In particular, the slip joint element allows the foam ducting to expand and contract without restraint, which leads to relative movement between the foam ducting and its fixed support bracket structure, so that traditional rigid supports cannot be used, and the sliding support element accommodates this movement.

Embodiments may be adapted for other applications in substantially any industry or application that uses foam or other ducting that is prone to axial movement.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system for accommodating movement of a foam ducting system, the system comprising:
a slip joint element including a male component configured to be installed on a first end of a first segment of a foam ducting and a female component configured to be installed on a second end of a second segment of the foam ducting, with the male component configured to be slidingly received within the female component such that when the first segment moves along a centerline axis of the foam ducting relative to the second segment the male component slides but remains received within the female component, and thereby maintains a connection between the first and second segments; and
a sliding support element including a receiver component configured to engage a fixed support bracket structure and a mounting component configured to be mounted on an exterior surface of the foam ducting, with the receiver component configured to be slidingly received within an elongated channel of the mounting component such that when the foam ducting moves along the centerline axis the receiver component slides but remains received within the channel, and thereby maintains a connection between the foam ducting and the fixed support bracket structure.

2. The system of claim 1, wherein the system is incorporated into an environmental control system of an aircraft.

3. The system of claim 1, wherein—
the male component includes—
a first receiver component configured to receive the first end of the first segment, and
a first extension component projecting outwardly from the first receiver component; and
the female component includes—
a second receiver component configured to receive the second end of the second segment, and
a second extension component projecting outwardly from the second receiver component, and configured to slidingly receive the first extension component of the male component when the male and female components are connected.

4. The system of claim 3, wherein the first receiver component includes a first channel for receiving the first end of the first segment, and the second receiver component includes a second channel for receiving the second end of the second segment.

5. The system of claim 3, wherein a first projection length of the first extension component and a second projection length of the second extension component are determined based on an expected maximum distance between the first and second ends of the first and second segments as the first and second segments move along the centerline axis.

6. The system of claim 1, wherein an elongation length of the channel feature is determined based on an expected maximum travel of the receiver component within the channel as the foam ducting moves along the centerline axis.

7. The system of claim 1, wherein the slip joint element further includes a stop feature configured to limit the maximum relative movement of the male and female components and thereby prevent the male and female components from disconnecting.

8. The system of claim 1, wherein the slip joint element further includes an air seal interposed between the male and female components and configured to reduce a loss of air from between the first and second segments.

9. The system of claim 1, further including a mechanical mechanism configured to secure the mounting component of the sliding support element to the exterior surface of the foam ducting.

10. The system of claim 1, further including a non-mechanical mechanism configured to secure the mounting component of the sliding support element to the exterior surface of the foam ducting.

11. A system for accommodating axial movement in a foam ducting system, a foam ducting including first and second segments, with each of the first and second segments having one or more walls constructed of foam and defining an elongated internal passage, wherein the foam ducting is subject to movement along a centerline axis due to thermal expansion and contraction, the system comprising:
a slip joint element including—
a male component configured to be installed on a first end of the first segment of the foam ducting, and
a female component configured to be installed on a second end of the second segment end of the foam ducting and to slidingly receive a portion of the male component,
wherein as the first end of the first segment of the foam ducting moves relative to the second end of the second segment along the centerline axis, the male and female components slide relative to each other while remaining engaged and maintaining an overall integrity of the elongated internal passage within the foam ducting; and
a sliding support element including—
a receiver component configured to engage a fixed support bracket structure,
a body component including a channel feature which is elongated parallel to the centerline axis, the channel feature configured to slidingly receive the receiver component, and
a mounting component associated with the body component and configured to secure the sliding support element to an exterior surface of the one or more walls of the foam ducting,
wherein as the foam ducting moves relative to the fixed support bracket structure along the centerline axis, the receiver component slides within the channel feature of the body component and remains engaged with the fixed support bracket structure.

12. The system of claim 11, wherein the system is incorporated into an environmental control system of an aircraft.

13. The system of claim 11, wherein—
the male component includes—
a first receiver component configured to receive the first end of the first segment, and
a first extension component projecting outwardly from the first receiver component; and
the female component includes—
a second receiver component configured to receive the second end of the second segment, and
a second extension component projecting outwardly from the second receiver component, and configured to slidingly receive the first extension component of the male component when the male and female components are connected.

14. The system of claim 13, wherein the first receiver component includes a first channel for receiving the first end of the first segment, and the second receiver component includes a second channel for receiving the second end of the second segment.

15. The system of claim 13, wherein—
a first projection length of the first extension component and a second projection length of the second extension component are determined based on an expected maximum distance between the first and second ends of the first and second segments as the first and second segments move along the centerline axis; and
an elongation length of the channel feature is determined based on an expected maximum travel of the receiver component within the channel feature as the foam ducting moves along the centerline axis.

16. The system of claim 11, wherein the slip joint element further includes a stop feature configured to limit the maximum relative movement of the male and female components and thereby prevent the male and female components from disconnecting.

17. The system of claim 11, wherein the slip joint element further includes an air seal interposed between the male and female components and configured to reduce a loss of air from between the first and second segments.

18. The system of claim 11, further including a mechanical mechanism configured to secure the mounting component of the sliding support element to the exterior surface of the one or more walls of the foam ducting.

19. The system of claim 11, further including a non-mechanical mechanism configured to secure the mounting component of the sliding support element to the exterior surface of the one or more walls of the foam ducting.

20. A system for accommodating axial movement in a foam ducting system, the system comprising:
first and second segments of a foam ducting, with each segment including one or more walls constructed of foam and defining an elongated internal passage, wherein the foam ducting is subject to movement along a centerline axis due to thermal expansion and contraction;
a slip joint element including—
a male component configured to be installed on a first end of the first segment of the foam ducting, the male component including—
a first receiver component having a first channel configured to receive and engage the first end of the first segment, and
a first extension component projecting outwardly from the first receiver component, and
a female component configured to be installed on a second end of the second segment end of the foam ducting, the female component including—
a second receiver component having a second channel configured to receive and engage the second end of the second segment, and
a second extension component projecting outwardly from the second receiver component, and configured to slidingly receive the first extension component of the male component when the male and female components are connected,
wherein a first projection length of the first extension component and a second projection length of the second extension component are determined based on an expected maximum distance between the first and second ends of the first and second segments as the first and second segments move along the centerline axis,
wherein as the first end of first segment of the foam ducting moves relative to the second end of second segment along the centerline axis, the first and second extension components slide relative to each other while remaining engaged and maintaining an overall integrity of the elongated internal passage within the foam ducting,
an air seal interposed between the first and second extension components and configured to reduce a loss of air from between the first and second segments, and
a stop feature configured to limit the maximum relative movement of the first and second extension components and thereby prevent the male and female components from disconnecting; and
a sliding support element including—
a receiver component configured to engage a fixed support bracket structure,
a body component including a channel feature which is elongated parallel to the centerline axis, the channel feature configured to slidingly receive the receiver component,
wherein an elongation length of the channel feature is determined based on an expected maximum travel of the receiver component within the channel as the foam ducting moves along the centerline axis, and
a mounting component associated with the body component and configured to secure the sliding support element to an exterior surface of the one or more walls of the foam ducting,
wherein as the foam ducting moves relative to the fixed support bracket structure along the centerline axis, the receiver component slides within the channel feature of the body component and remains engaged with the fixed support bracket structure.
